(19) United States
(12) Patent Application Publication
(10) Pub. No.: US 2010/0282741 A1
(43) Pub. Date: Nov. 11, 2010

(54) METHOD FOR CONTROLLING AND OPTIMIZING MICROWAVE HEATING OF PLASTIC SHEET

(75) Inventors: Ronald Van Daele, Belsele (BE); Ray A. Lewis, Midland, MI (US); Robert P. Haley, JR., Midland, MI (US)

Correspondence Address: The Dow Chemical Company;Osha Liang LLP, Two Houston Center, 909 Fannin Street, Suite 3500, Houston, TX, 77010-2002, US

(73) Assignee: DOW GLOBAL TECHNOLOGIES INC., Midland, MI (US)

(21) Appl. No.: 12/743,601

(22) PCT Filed: Nov. 17, 2008
(86) PCT No.: PCT/US2008/083803

§ 371 Date: May 19, 2010

Related U.S. Application Data
(60) Provisional application No. 60/991,167, filed on Nov. 29, 2007.

(51) Int. Cl. H05B 6/64

(52) U.S. Cl. 219/679

(57) ABSTRACT

A method for processing a thermoplastic material (46), the method including: passing a thermoplastic material through a microwave heating apparatus (40) a a selected feed rate; wherein the microwave heating apparatus comprises: a microwave emitter for supplying microwave energy to a resonant cavity (43); the resonant cavity comprising at least one inlet and at least one outlet, the inlets and outlets collectively forming a passageway (49) for passing the thermoplastic material through the resonant cavity; and a movable piston (48) configured to adjust a length of the resonant cavity; exposing the thermoplastic material to microwaves in the resonant cavity, wherein the exposing causes an increase in temperature of at least a portion of the thermoplastic material; measuring an e-field generated by the microwave emitter; and adjusting a position of the movable piston in response to the measured e-field; and, processing the thermoplastic material.

### BACKGROUND OF DISCLOSURE

1. Field of the Disclosure

Embodiments disclosed herein relate generally to microwave emitters and the use of microwave energy to selectively heat thermoplastic polymer systems.

2. Background

Thermoplastic polymer pellets typically must be melted, re-shaped and cooled in a primary conversion process, such as extrusion or injection molding, in order to make parts of commercial value. In some instances, a secondary fabrication process, such as thermoforming, which involves further heating, reshaping, and cooling is required to achieve parts of commercial value. In both primary and secondary processes, heat energy is applied to the thermoplastic and is subsequently removed after reshaping has occurred.

Conventional heating mechanisms for thermoplastic polymer systems in many instances rely on contact or radiant heat sources. Radiant energy, commonly referred to as infrared, has a wavelength in the range of 1 to 10 microns and will penetrate absorbing materials to a depth of approximately 1 to 2 microns before half of the available energy has been dissipated as heat. The process of heat transfer continues through a process of conduction (in the case of a solid material) or a combination of conduction, convection and mechanical mixing in the case of a molten material. Contact heating similarly relies on conduction (or a combination of conduction, convection, and mixing) from the hot contact surface to heat the “bulk” of the material.

The rate of heat transfer (RHT) associated with a conductive heat transfer process can generally be described by the relationship: RHT=f(A, Ct, Delta T), where A is the area available for heat transfer, Ct is the thermal diffusivity of the material, and Delta T is the available temperature driving force, which will decrease with time as the temperature of the material being heated increases. The thermal diffusivity, Ct, of unmodified thermoplastics is inherently low, thereby impeding the heat transfer in a conventional radiant or contact heating system. Furthermore, radiant or contact heating may result in an undesirable temperature gradient, potentially overheating or scorching the skin of the material being heated.

By way of contrast, microwaves have a wavelength of approximately 12.2 cm, large in comparison to the wavelength of infrared. Microwaves can penetrate to a much greater depth, typically several centimeters, into absorbing materials, as compared to infrared or radiant energy, before the available energy is dissipated as heat. In microwave-absorbing materials, the microwave energy is used to heat the material “volumetrically” as a consequence of the penetration of the microwaves through the material. However, if a material is not a good microwave absorber, it is essentially “transparent” to microwave energy.

Some potential problems associated with microwave heating include uneven heating and thermal runaway. Uneven heating, often due to the uneven distribution of microwave energy through the part, may be overcome to a certain extent, such as in a conventional domestic microwave oven, by utilizing a rotating platform to support the item being heated. Thermal runaway may be attributed to the combination of uneven heating outlined above and the changing dielectric loss factor as a function of temperature.

Microwave energy has been used, for example, to dry planar structures such as wet fabrics. Water is microwave sensitive and will evaporate if exposed to sufficient microwave energy for a sufficient period of time. However, the fabrics are typically transparent to microwaves, thereby resulting in the microwaves focusing on the water, which is essentially the only microwave-sensitive component in the material. Microwave energy may also be used to heat other materials, such as in the following references.

U.S. Pat. No. 5,519,196 discloses a polymer coating containing iron oxide, calcium carbonate, water, aluminum silicate, ethylene glycol, and mineral spirits, which is used as the inner layer in a food container. The coating layer can be heated by microwave energy, thereby causing the food in the container to brown or sear.

U.S. Pat. No. 5,070,223 discloses microwave sensitive materials and their use as a heat reservoir in toys. The microwave sensitive materials disclosed included ferrite and ferrite alloys, carbon, polyesters, aluminum, and metal salts. U.S. Pat. No. 5,338,611 discloses a strip of polymer containing carbon black used to bond thermoplastic substrates.

WO 2004048463A1 discloses polymeric compositions which can be rapidly heated under the influence of electromagnetic radiation, and related applications and processing methods.

A key limitation to the use of microwaves for heating polymeric materials is the low microwave receptivity of many useful polymers. The low microwave receptivity of the polymers thus requires either high powers or long irradiation times for heating such polymeric systems. In polymers designed specifically for microwave absorption, there is often a trade-off between their microwave properties and mechanical or thermal properties, i.e., the mechanical and thermal properties are often less than desirable.

Another key limitation to the use of microwaves for heating polymeric materials is the limited availability of microwave heating devices suitable for or capable of effectively processing and heating polymeric materials on a continuous or semi-continuous basis. This is especially true where the materials to be processed are large in size.

U.S. Patent Application Publication No. 20030183972 discloses a method and apparatus for molding balloon catheters employing microwave energy. Microwave energy generated by a gyrotron is directed toward the mould, to heat the polymeric material without heating the mould. The balloon can be further heated by additional microwave energy. Also disclosed is a polymer extrusion apparatus utilizing microwave energy for heating polymer feedstock material within the extruder tip and die prior to product formation.

WO2004/009646 discloses the use of microwave energy to aid in altering the shape and in post-production processing of fiber-reinforced composites. A silane based sizing on the fibers is thermally degraded in the pre-heating die leaving carbon deposits on the fiber. The fibers are then pultruded and coated in extruded thermoplastic. The carbon deposits then allow the use of microwave energy in the post-production processing of the article, e.g. heating for physical deformation and welding.

U.S. Pat. No. 3,843,861 discloses an apparatus for the microwave heating and vulcanization of rubber or synthetic material. U.S. Pat. No. 6,211,503 discloses a device and method of heating components made of microwave absorbing plastic. The device uses a microwave generator, antenna, and a tube-like device to process the material. The tube-like device into which the microwaves are injected shields the outside world from microwaves and is designed with an inside diameter smaller than half the wavelength (about 12 cm for microwaves), to form a very strong, single mode field within the cavity. This device may allow roughly homogeneous heating of parts, but only for very small parts (<6 cm in size).

U.S. Pat. No. 7,034,266 discloses a tunable microwave apparatus for use in the manufacture of disposable absorbent articles. The microwave activates a binder fiber material to operatively provide a plurality of interconnections between absorbent fibers and binder fibers. The microwave apparatus may be used for the microwave heating of a continuous web of interconnected materials or a series of individual absorbent bodies connected by a web of tissue, non-woven, or other carrier material.

U.S. Pat. No. 5,302,993 discloses a compact developing apparatus which utilizes a microwave heating system to heat a fluid. The temperature of the fluid is controlled using feedback or feedforward control loops to control the microwave output.

Accordingly, there exists a need for microwave heating apparatuses (equipment), and processes using the same, for the rapid, controllable volumetric heating of polymeric materials using microwave energy. Additionally, there exists a need for materials, equipment, and processes that have the ability to controllably heat or melt only a portion of a polymeric material, sufficient to render the bulk material capable of flow, facilitating the shaping or further processing of the polymer.

### SUMMARY OF DISCLOSURE

In one aspect, embodiments disclosed herein relate to a method for processing a thermoplastic material, the method including: passing a thermoplastic material through a microwave heating apparatus at a selected feed rate; wherein the microwave heating apparatus includes: a microwave emitter for supplying microwave energy to a resonant cavity; the resonant cavity including at least one inlet and at least one outlet, the inlets and outlets collectively forming a passageway for passing the thermoplastic material through the resonant cavity; and a movable piston configured to adjust a length of the resonant cavity; exposing the thermoplastic material to microwaves in the resonant cavity, wherein the exposing causes an increase in temperature of at least a portion of the thermoplastic material; measuring an e-field generated by the microwave emitter; and adjusting a position of the movable piston in response to the measured e-field; and, processing the thermoplastic material.

In another aspect, embodiments disclosed herein relate to an apparatus for heating a thermoplastic material, wherein the thermoplastic material has a microwave-sensitive polymeric region, the apparatus including: a microwave emitter for supplying microwave energy to a resonant cavity; the resonant cavity including at least one inlet and at least one outlet, the inlets and outlets collectively forming a passageway for passing the thermoplastic material through the resonant cavity; a movable piston configured to adjust a length of the resonant cavity; an e-field sensor for measuring an e-field generated by the microwave emitter; and a control system for adjusting a position of the movable piston based on data received from the e-field sensor.

Other aspects and advantages of embodiments disclosed herein will be apparent from the following description and the appended claims.

### BRIEF DESCRIPTION OF DRAWINGS

FIG. 1 illustrates an embodiment of a microwave heating device containing multiple microwave circuits.

FIG. 2 illustrates a microwave heating and thermoforming apparatus useful in embodiments disclosed herein.

FIG. 3A is a simplified schematic of a microwave circuit according to embodiments disclosed herein.

FIG. 3B illustrates resonance of a microwave circuit as a function of piston displacement, according to embodiments disclosed herein.

FIG. 4 illustrates a fluttering piston useful in embodiments of a microwave tuning circuit disclosed herein.

FIG. 5 is a graphical representation of dynamic tuning a microwave circuit according to embodiments disclosed herein as compared to a microwave circuit tuned using a stationary sample.

### DETAILED DESCRIPTION

In one aspect, embodiments disclosed herein relate to a microwave heating apparatus for heating polymers. In another aspect, embodiments disclosed herein relate to a microwave heating apparatus having multiple microwave emitters, useful in processing large polymeric structures. The polymers may incorporate microwave-receptive components, either on the backbone of the polymer or as polymeric or non-polymeric additives in the polymer, which may allow the polymer to be heated rapidly and controllably through the application of microwave energy. In other aspects, embodiments relate to methods for processing microwave-heatable polymeric compositions in a microwave heating apparatus, where the microwave heating apparatus includes a control system for the dynamic tuning of the microwave circuit.

Compared to alternative methods of heating, such as radiant, convective, or contact heating, the use of microwave energy may result in very rapid, volumetric heating. The use of microwave energy may overcome two fundamental limitations of the conventional heating systems: the dependence on the thermal conductivity of the polymer to transport heat energy form the surface of the part; and the maximum allowable temperature of the polymer surface which in turn determines the maximum available temperature driving force.

A polymer may inherently be receptive to microwaves based upon its chemical composition. Alternatively, a microwave sensitive polymer composition may be formed by combining a microwave receptive additive with a base polymer which is non-receptive to microwaves. Suitable base polymers, microwave receptive polymers, and microwave receptive additives useful in embodiments disclosed herein are described in PCT Application Nos. PCT/US2007/012821, PCT/US2007/012822, and PCT/US2007/012817, and U.S. Provisional Patent Application Ser. No. 60/932,790, each of which are incorporated herein by reference. The resulting microwave-receptive or microwave-sensitive polymers may be heated using microwave energy, in lieu of or in combination with radiant, convective, or contact heating. The heated polymer may then be processed, such as mixed, transferred, shaped, stamped, injected, formed, molded, extruded or otherwise used in a primary conversion process or a secondary fabrication process to form useful articles.

Embodiments disclosed herein relate to the efficient conversion of thermoplastic materials using electromagnetic energy, by selectively heating a portion of the volume of the thermoplastic material, that portion being sufficient to render the material processable in a subsequent forming technique. As used herein, processable means the provision of sufficient melt-state or softening of at least a portion of the thermoplastic in order for the bulk plastic to be mixed, transferred, shaped, stamped, injected, extruded, etc., to form a product. The heating of the thermoplastic substrate may be achieved by the exposure of the thermoplastic to electromagnetic energy, such as microwaves, which have the ability to penetrate through the entire volume of the substrate and to be preferentially absorbed in microwave sensitive regions.

By applying microwave radiation, heat may be generated locally at a predetermined region of the volume, bulk, or part of the polymer specimen. Thus, the amount of energy applied may be carefully controlled and concentrated, as other regions may consist of non-absorbing materials which are transparent to the radiation used. For example, untreated polypropylene and polyethylene are transparent to microwave radiation. By focusing on materials that are receptive to microwaves, the energy used may be reduced, the cycle times shortened and the mechanical and other properties of the final material may be adapted and optimized for various requirements and applications.

Sites within the microwave sensitive material may be either favorable or non-favorable for absorption of the electromagnetic energy. Sites that are favorably absorptive will readily and rapidly heat under the influence of electromagnetic energy. In other words, only a specified portion of the volume of the substrate will be strongly affected by the electromagnetic energy, relative to other regions of the material.

In this manner, the electromagnetic energy interacts with the substrate or certain regions of the substrate, which will increase in temperature when electromagnetic energy is present. As the material is heated volumetrically, the material may be converted into a processable state more rapidly as compared to conventional heating techniques. Moreover, because that material may contain less heat energy than would normally be present had the entire bulk material been heated via surface conduction (infrared heating), there may be considerable savings in energy. For example, infrared heating results in significant energy losses to the atmosphere, and requires that the surface temperature of the part is significantly higher than the desired bulk temperature in order to effect an acceptable rate of heat transfer from the part surface to the part core and raise the core temperature to that required for processing. In contrast, microwave heating, which causes the temperature of the microwave sensitive polymer to heat rapidly and volumetrically to processing temperature, may result in a significantly lower polymer surface temperature. Microwave heating may also have less of a tendency for energy to be lost from the system, transferring energy primarily to where it is needed, i.e. the microwave sensitive polymer. Microwave heating may also result in considerable savings in cycle time for a conversion process. The heating time may be reduced, not only because the microwave heating mechanism occurs rapidly throughout the bulk (in contrast to thermal conduction), but the total energy content of the part is less. The cooling cycle may also be reduced as the unheated regions of material effectively act as heat sinks to draw heat out of the neighboring heated regions, significantly enhancing the overall cooling rate of the bulk material.

The microwave sensitive polymer may be used during the primary conversion or secondary fabrication processes. For example, in some embodiments, the microwave sensitive polymer may be used during the fabrication of polymeric articles including films, foams, profiles, compounded pellets, fibers, woven and non-woven fabrics, molded parts, composites, laminates, or other articles made from one or more polymeric materials. In other embodiments, the microwave sensitive polymer may be used in conversion processes such as sheet extrusion, co-extrusion, foam extrusion, injection molding, foam molding, blow molding, injection stretch blow molding, and thermoforming, among others.

Microwave Heating Device and Control of the E-Field

An industrial microwave oven typically includes three main components: an oven cavity where objects can be bombarded with microwaves, a magnetron which produces the microwaves, and a wave guide which transfers microwaves to the oven cavity. A continuous microwave oven typically includes a vestibule which may act to trap all non-absorbed microwave energy so that radiation is prevented from escaping into the surroundings. Microwave heating devices useful in embodiments disclosed herein are disclosed in PCT Application Nos. PCT/US2007/012821, PCT/US2007/012822, and PCT/US2007/012817, and U.S. Provisional Patent Application Ser. No. 60/932,790, each of which are incorporated herein by reference, including microwave apparatus having multiple resonant cavities.

The use of multiple resonant cavities may provide a uniform energy density and high field strength, resulting in rapid, uniform heating of a microwave-sensitive material. Multiple resonant cavities may be preferred where the material to be heated is larger than could be effectively heated using a single emitter, such as for a polymeric sheet having substantial width.

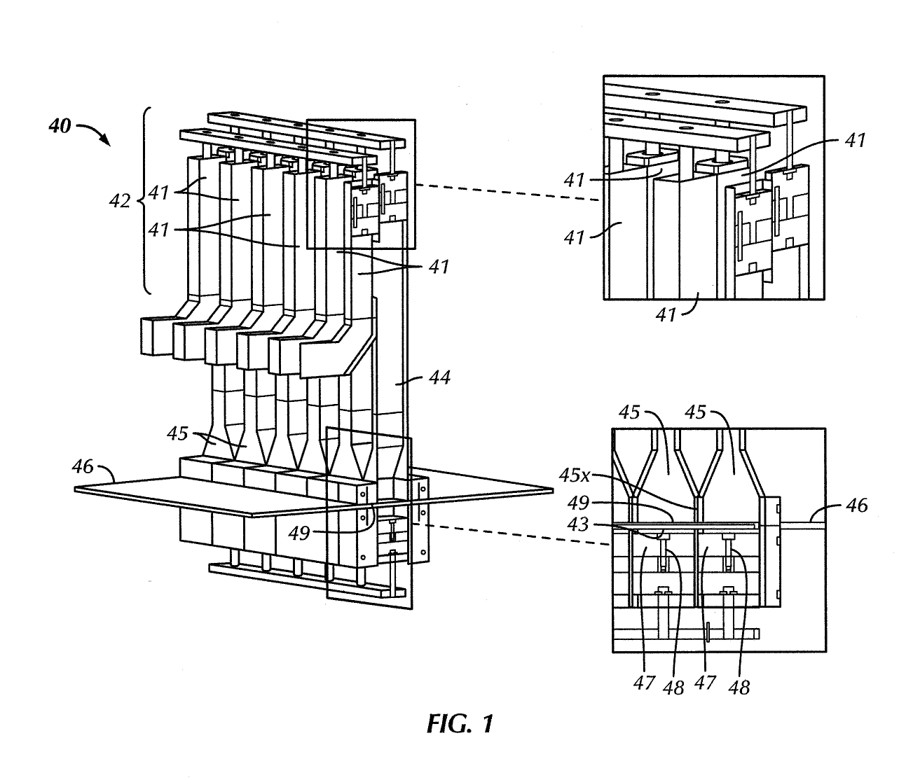

Referring now to FIG. 1, one configuration for a multiple resonant cavity array is illustrated. The heating apparatus 40 may include one or more microwave circuits 41, including at least one microwave generator and other equipment (described below) to control or direct the microwave energy to the multiple resonant cavities 43. The microwave energy may then impact a microwave-sensitive or microwave receptive material 46, such as a microwave-sensitive polymeric sheet, in the resonant cavities 43. Microwave chokes 47 may be used to minimize the leakage of microwave energy from the array.

Regarding the microwave circuits and other equipment that may be used to control or direct microwave energy to the multiple resonant cavities 43, any equipment that may be used for processing microwave energy may be used. For example, section 42 may include equipment to direct and control energy from a microwave generator to resonant cavities 43, including tuning devices and other circuitry to minimize feedback of reflected energy to the microwave generator; and a waveguide 44 may direct microwave energy through horn 45, which may provide a uniform microwave energy density spread to resonant cavities 43. Other equipment that may be used includes: horns, waveguides, microwave antennae, circulators, isolators, duplexers, phase shifters, twin stub tuners, four stub tuners, EH tuners, network analyzers, e-field probes, infrared pyrometers, variable power sources, and other equipment known to those skilled in the art.

As illustrated, heating apparatus 40 contains a bank of 12 microwave circuits 41 (2 rows of 6), which may operate in conjunction to uniformly heat sheet 46. Various other arrangements of the microwave circuits may also be used, including a linear array, where the arrangement is such that the desired portions of the polymeric sheet 46 may be heated. The various arrangements may result in adjacent microwave circuits 41 heating adjacent or overlapping portions of the material to be heated, such as sheet 46.

Feed slot 49, as mentioned above, may be a single passageway (the array having, overall, one inlet and one outlet) for the material to be heated to be passed through the resonant cavities. In some embodiments, a thermoplastic material may be passed through a microwave heating apparatus at a selected and/or variable feed rate. In some embodiments, the feed rate may range from 0.1 mm/second to 100 mm/second; from 0.5 to 75 mm/second in other embodiments; from 1 to 50 mm/second in other embodiments; and from a lower limit of 0.5, 1, 2, 3, 4, 5, or 10 mm/second to an upper limit of 5, 10, 15, 20, 25, 30, 35, 40, 50, 75, or 100 mm/second in yet other embodiments, where any combination of upper and lower limits may be used.

Microwave chokes 47 may be configured to minimize microwave leakage from the multiple resonant cavities through the inlets and outlets. Additionally, feed slots 49 may be adjustable to accommodate various sizes (thickness and/or width) of sheet passing through the inlet and outlet, and may also be adjustable in relation to cavities 43 such that the sheet may pass through a maxima in e-field in the resonant cavities 43.

Movable pistons 48 may be vertically adjusted to change the effective length of the resonant cavity. Movable pistons 48 may, for example, effectively adjust the length from the iris plates to the bottom of the resonant cavity, allowing for tuning of the resonant cavity in relation to the microwave frequency, allowing a standing wave to develop. A control system may control the multiple cavity array as a single unit. In this manner, the individual pistons may be individually adjusted to tune the respective resonant cavities. Due to minor variations in the operating parameters for each microwave emitter—resonant cavity combination, the ability to fine tune each microwave circuit may be preferred.

Although FIG. 1 illustrates an embodiment having 12 microwave circuits, other embodiments may contain one or more emitters to heat sheet specimens. For example, the number of microwave circuits may be based upon the size of the microwave generator(s), the size of the material being processed, and the heating rate desired, among other variables.

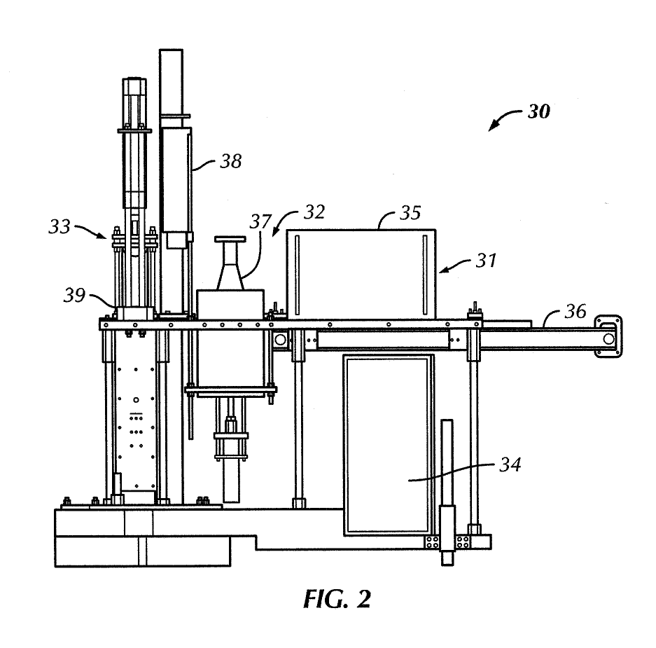

Referring now to FIG. 2, an embodiment of thermoforming equipment 30 incorporating a microwave heating apparatus as described herein is illustrated. Thermoforming equipment 30 may include feed stage 31, heating stage 32, and forming stage 33, each of which may be controlled and or powered by wiring from an electrical cabinet 34. Polymer sheets or blanks 35 may be intermittently fed to heating stage 32 using a drive belt 36 to transport the polymer sheets or blanks 35. Once loaded into heating stage 32, microwave heating apparatus 37 may be used to expose polymer sheets or blanks 35 to microwave energy, where microwave heating apparatus 37 may include equipment as described above (microwave generators, tuners, horns, waveguides, etc.). Once heated, the polymeric sheets or blanks 35 may be transported to thermoforming stage 33. During transport to thermoforming stage 33, an infrared camera 38 or other equipment may be used to monitor the temperature of polymer sheet 35, to insure that polymer sheet 35 is at the desired temperature or temperature profile, and may also be used to control microwave heating apparatus 37. Once loaded into thermoforming stage 33, polymer sheet 35 may be formed using mold 39, such that a desired shape or part is formed.

As mentioned above, more than one microwave circuit may be used to heat a microwave sensitive polymer. Multiple microwave circuits may be preferred where the material to be heated is larger than could be effectively heated using a single circuit. One configuration for a multiple circuit array may be a linear array of heating units. In this case, each unit may sit next to the adjacent unit in a line. The units may be closely coupled to one another mechanically, such that the inlet and outlet feed slots of the multiple cavities form a combined feed slot, capable of handling a material greater in size than any single emitter could handle individually. The separation between the adjacent resonant cavities may be relatively small and designed such that relatively uniform temperature rise may be achieved across whole sheet during processing. The individual microwave circuits may heat adjacent regions of the material passing through the array. In some embodiments, individually powered units may establish a uniform high intensity microwave field across a polymeric sheet and rapidly heat the sheet as it moves through the array, to the temperature required to shape or form the material as desired, reducing the overall cycle time of the heating process prior to the forming operation.

As mentioned above, for a given length of the resonant cavity and frequency of microwave radiation emitted from the microwave generator, a standing wave may be established within the resonant cavity. This standing wave may enable very high electric field strengths to be established within the resonant cavity.

Tuning of a microwave circuit and the resonant cavity may be performed by optimizing the E-field by moving the adjustable piston with a stationary sample. For example, a sample may be disposed in the heating unit, the microwave chokes adjusted to minimize microwave leakage, and power may be supplied to the microwave generator. The resulting E-field can be measured with a diode sensor and the movable piston adjusted to a single location to resonate the microwaves. After tuning, the sample may be conveyed through the microwave field and heated to a thermoforming temperature. The E-field and sample temperature may be monitored as it moves through the process, using equipment as mentioned previously, such as E-field probes, IR sensors, and the like.

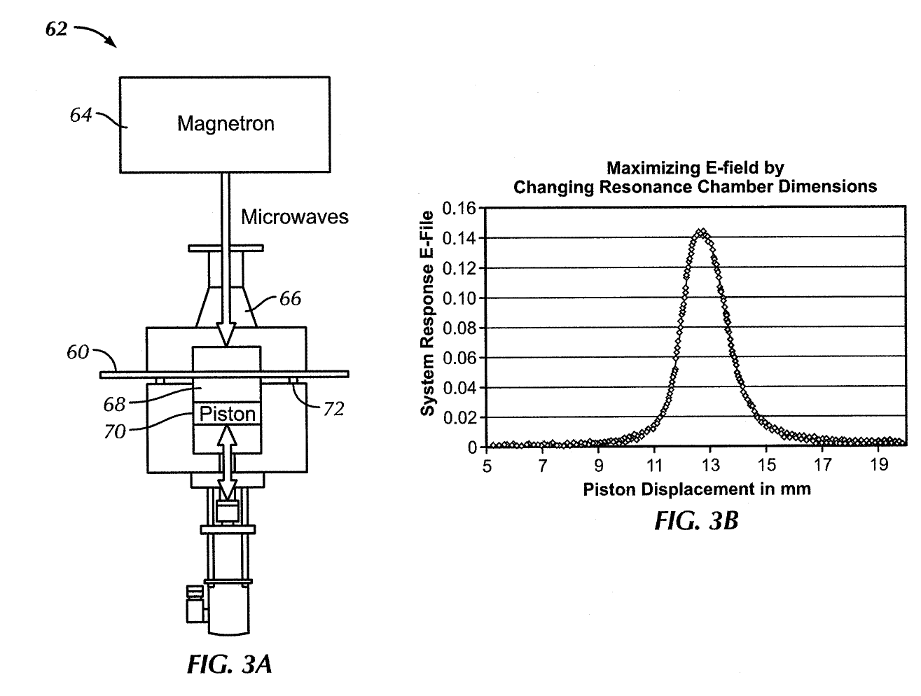

One example of tuning a microwave circuit is illustrated in FIGS. 3A and 3B. As illustrated in FIG. 3A, a substrate 60 is disposed in a microwave heating apparatus 62, which may include a magnetron 64, a horn 66, resonant cavity 68, movable piston 70, and microwave chokes 72. The E-field is measured as a function of piston displacement, the results of which are illustrated in FIG. 3B. The E-field is at a maximum at a piston displacement of approximately 12.5 mm. This illustrates the ability to control the E-field and resonance of the microwaves in the resonant cavity 68 via adjustment of the position of the piston 70.

Microwave-heatable substrates, including polymeric sheet, may have an average thickness resulting from extrusion processes, for example. However, the thickness may vary over the width and length of the sheet. Additionally, compositional variances may also be encountered across the width and length of the sheet. Other variables that may affect microwave circuit tuning may include substrate location within the cavity, substrate material type, moisture (within the substrate or atmospheric), and other factors. These variables may result in an unstable E-field when processing a moving substrate, which may result in insufficient heating of the substrate or non-uniform heating of the substrate. This, in turn, may result in the inability to properly process the substrate, such as thermoforming a sheet.

Processing of a moving substrate may require the closed loop control of the E-field. A consistent E-field results in uniform heating and a uniform temperature distribution across a sheet, essential for thermoforming plastic sheet. Closed loop control of the E-field may overcome any subtle or even gross differences in the substrate as it is conveyed through the microwave field. Resonance may be measured, for example, by monitoring the E-field inside the cavity or waveguides, or by monitoring the temperature of the material of interest, either inside or outside the cavity. Closed loop control may be effected by controlling one or more of the position of the adjustable piston, the power input to the microwave generator, the settings of a phase shifter, iris plate diameter, temperature or dielectric properties of the sheet, and others.

In one embodiment, closed loop control of the E-field with piston location may be accomplished with an E-field diode sensor, a programmable logic controller (PLC), and piston actuator hardware, for example. Programmable software may also be used to optimize the response of the controller. The movement of the piston may be performed by any means, such as hydraulics, pneumatics, or other known methods of linearly displacing the piston, including electrical or magnetic methods.

Further control of the heating of the polymeric sheet may result through incorporation of control over the intensity of the microwave field. For example, a variable power source may be operatively coupled to the microwave generator. A PLC and related software may be used to control the power input to the microwave generator in response to, for example, temperature of the sheet exiting the microwave heating apparatus.

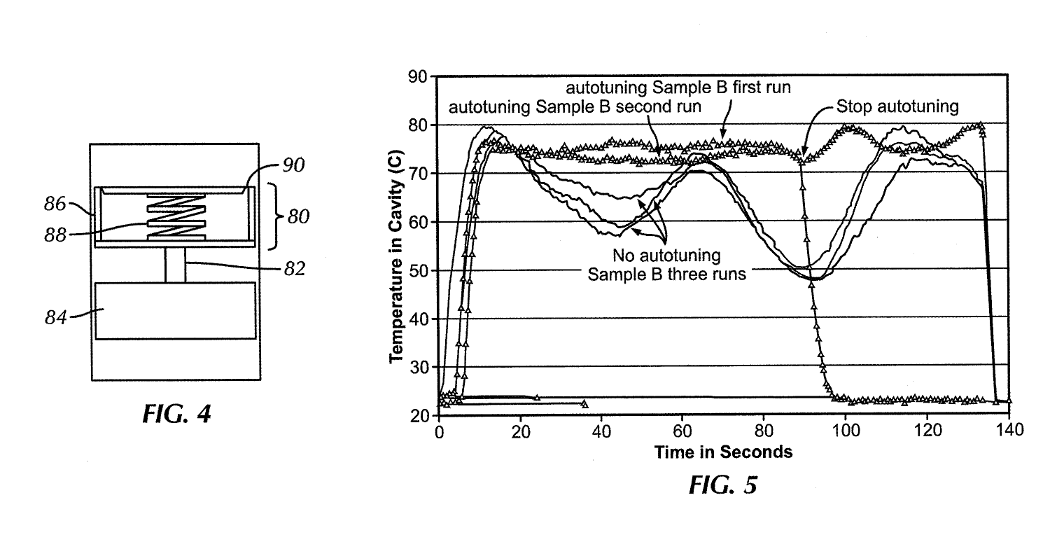

Referring now to FIG. 4, close-loop control may also be achieved with a new piston which enables searching for the resonance by “fluttering” the top of the piston. The position of piston 80 is adjustable, as above. As illustrated in FIG. 4, the piston may be adjustable via rod 82 and pneumatic cylinder 84. Electromagnetically speaking, the piston will function as the above-described solid metal piston. Piston 80 may include casing 86, coil 88, and piston top 90. Coil 88 may be used to oscillate piston top 90. In some embodiments, coil 88 may displace piston top 90 a distance of 1 mm or less.

Allowing the piston top to oscillate sufficiently fast may result in the piston position over-shooting and under-shooting the resonance position. This means the resonance position is analogous to a DC offset (or average position) for the piston top. Therefore, derivative information may be uncovered that allows the PLC to know which direction the new DC offset is from the current DC offset.

Piston top 90 may be allowed to oscillate at a frequency which can be adaptively updated. The adaptive control may benefit the system as the searching rate (slew rate and sensitivity) depends on the material electric permittivity and magnetic permeability. Additionally, there may be a minimum frequency that may be adaptively identified so that the required slew rate to the new DC offset is achieved. In other words, the piston must move fast enough to maintain the resonance condition so that the heating rate is maintained.

The algorithm for realizing control of the microwave system does not have to be unique. In some embodiments, however, certain optimizations must take place. For example, on embedded microcontrollers memory (ROM and RAM), execution speed optimization could require certain algorithmic features not commonly known.

The frequency of the oscillation of piston top 90 should be proportional to the speed at which the measured control signals change. Typical frequencies may be in the range of 1 Hz-1 kHz, depending on the speed of material transport through the applicator and the subsequent varying E-field. However, if the transportation speed is high and the E-field changes are equivalently high, higher oscillation frequencies may be used. The control system should be sufficiently fast to both acquire the data and response fast enough to the changing control measurement(s). In some embodiments, the fluttering piston may oscillate with a high enough frequency that the heating of the polymeric sheet will not be affected, fast enough that the DC offset can be adjusted continuously, and slow enough that the E-field can be measured.

As described above, microwave heating apparatus used in embodiments described herein may include a movable piston to adjust a length of the resonant cavity. As described above, for a given cavity length and frequency of microwave radiation, a standing wave may be established within resonant cavity. This standing wave may enable very high electric field strengths to be established within resonant cavity. The variable length of the resonant cavity (in the direction of the standing wave) afforded by the movable piston may enable the fine tuning of the resonant cavity. The ability to fine tune the resonant cavity may allow the microwave heating of materials having varied sizes and dielectric properties. Moreover, the position of the movable piston may be used to reduce or minimize the amount of leakage of microwave energy from resonant cavity 6 through the cavity inlets and outlets. Microwave chokes (not shown) may also be used to prevent leakage of microwave energy through the cavity inlets and outlets.

As described above, the microwave heating apparatus may be tuned to generate a standing wave, to reduce leakage, to minimize adverse effects of reflected energy, and to match the resonant frequencies of materials to be heated with the microwave heating apparatus. Tuning may also include phase shifters, tuning devices, varying the position of the iris plate relative to the microwave generator, varying the length of the resonant cavity, and varying the position of a material to be heated within the cavity.

The resulting electric (electromagnetic) field within the resonant cavity may result in a uniform band of heating across the material being heated. By moving the material (such as a sheet) through inlets and outlets (feed slots), the material may pass through the resonant cavity and is heated upon exposure to the microwave field. The rate of heating of the material moving through resonant cavity may be varied, such as by varying the speed of passage of the material through resonant cavity or by varying the electric field strength within resonant cavity, such as by manipulating the position of the movable piston or the power input to the microwave generator.

In other embodiments, microwave apparatus disclosed herein may include other components typically used in a microwave system and known to those skilled in the art. For example, the microwave systems disclosed herein may include directional couplers, amplifiers, attenuators, transformers, transmission lines, antennas, connectors, couplers, splitters, oscillators, and microwave impedance tuners, among others.

Microwave heating apparatuses disclosed herein may be used to heat a thermoplastic material having a microwave-heatable region by passing the material through the resonant cavity. The microwave energy channeled from the microwave generator to the resonant cavity may heat the microwave-heatable region, allowing the thermoplastic material to be processed, as described above.

Microwave heating apparatuses disclosed herein may be capable of rapid and uniform heating of polymers, and may adapt to the nature of the microwave sensitive polymer (receptor type, receptor concentration, matrix type, etc.) and the form of the material being processed (thickness, shape, etc.). For example, in various embodiments, microwave heating apparatuses disclosed herein may include a variable power source, the horn may provide a uniform energy density spread; and various tuning devices may allow for fine tuning of the microwave wavelength emitted. In this manner, the microwave heating apparatus may be tailored to efficiently heat a particular substrate.

Analytical measurement devices (not shown) may also be provided to monitor or enhance the performance of the microwave heating apparatus. A thermal imaging device, such as an infra-red pyrometer, temperature sensors, thermocouples, and the like installed within a horn, inside or outside of a resonant cavity, or any other suitable location, may monitor the temperature of the material being processed, and may provide a real-time temperature reading of the material. These thermal imaging devices may be used to monitor temperature evolution during the process, usually prior to forming of the heated material. For example, an infra-red pyrometer may be placed within the horn, looking down onto the material being heated within the cavity. The infra-red pyrometer may monitor the real-time sample surface temperature. Data from the infra-red pyrometer may be fed to a controller which in turn may alter the speed of transit of the material being heated, microwave power input, and other process variables to attain the desired degree of heating. Control of heating in this manner may enable a final uniform temperature distribution across the material being heated, both axially and perpendicular to the axis (across the width and thickness of the sheet).

The selected power rating for the microwave emitter used may depend on the size or thickness of the polymer specimen being heated. The power rating may also be selected based on variables such as the cycle time for operations occurring upstream or downstream from the heating stage. In certain embodiments, a variable power source may be employed, providing process flexibility, such as the ability to vary a part size or composition (amount or type of microwave receptive additive).

In some embodiments, the microwave emitter may have a constant or variable power rating in the range from 100 W to 1,000 kW. In other embodiments, the power rating may range from 500 W to 500 kW; from 1 kW to 100 kW in other embodiments; from 5 kW to 75 kW in other embodiments; and from 10 kW to 50 kW in yet other embodiments. In certain embodiments, the power rating may range from 15 kW to 40 kW; and from 20 kW to 30 kW in yet other embodiments. In other embodiments, the power rating may range from a lower limit of 10, 20, 50, 100, 500, 1000, or 5000 W to an upper limit of 5, 10, 15, 20, 25, or 30 MW.

Other embodiments may contain one or more emitters to heat sheet specimens, where the number of emitters employed may be based upon the emitter size, sheet size, heating rate desired, and other variables. In some embodiments, sheet thicknesses may range from 0.01 mm to 10 cm; from 0.1 mm to 7.5 cm in other embodiments; and from 0.25 cm to 5 cm in yet other embodiments. In other embodiments, multiple emitter arrays disclosed herein may be used for thick sheet applications, where the sheets may have a thickness up to 15 cm; up to 10 cm in other embodiments; up to 5 cm in other embodiments; and up to 2.5 cm in yet other embodiments.

Multiple emitters arrays described herein may also allow for the processing of sheets having substantial widths. For example, embodiments disclosed herein may process sheets having a width of 10 feet or more; 8 feet or more in other embodiments; 6 feet or more in other embodiments; 4 feet or more in other embodiments; and 2 feet or more in yet other embodiments.

The aspect ratio of sheet that may be processed in a multiple emitter array may range from 1 to 5000 in some embodiments, where the aspect ratio is defined as average width divided by average thickness. In other embodiments, the aspect ratio may range from 10 to 2500; from 50 to 1000 in other embodiments; and from 100 to 500 in yet other embodiments.

For the above described sheet thicknesses, widths, and aspect ratios, the sheet length may be any desired length. Sheet length may depend on whether the downstream processes are configured to process a continuous sheet, such as from a roll, for example, or configured to process a sheet of finite length. Accordingly, sheet length may vary from a few centimeters to an infinite length.

Regardless of sheet width, length, or thickness, multiple emitter arrays disclosed herein may provide for selective heating of selected sheet regions in some embodiments, and may provide for rapid, uniform heating of the sheet in other embodiments. As used herein, rapid heating may refer to the heating of at least a portion of the sheet at a rate of at least 5° C. per second in some embodiments; at least 10° C. per second in other embodiments; at least 20° C. per second in other embodiments; at least 30° C. in other embodiments; and at least 50° C. in yet other embodiments. As used herein, uniform heating may refer to the heating of a sheet, or at least a selected portion of a sheet, wherein the heated portion has a maximum temperature variance of 10° C. or less in some embodiments; 7.5° C. or less in other embodiments; 5° C. or less in other embodiments; 4° C. or less in other embodiments; and 3° C. or less in yet other embodiments. By comparison to conventional infrared heating, the heating rates and temperature variances afforded by various embodiments of the microwave heating apparatuses disclosed herein may provide an advantage in cycle times, reduce the deleterious effects on the polymer due to excess heat exposure, as well as provide for improved processing.

The above described microwave heating apparatuses may be used to heat various polymeric materials, including microwave receptive polymers and composites including polymeric materials and microwave receptive additives.

Applications

As described above, the microwave heating apparatuses disclosed herein may be used to heat a polymer for subsequent processing, such as being mixed, transferred, shaped, stamped, injected, formed, molded, extruded, or otherwise further processed. In some embodiments, microwave heating apparatuses disclosed herein may be useful in thick sheet thermoforming processes, such as for forming refrigerator liners, for example. In other embodiments, microwave heating apparatuses disclosed herein may be useful for heating, binding, or processing air laid binder fibers, for example. In other embodiments, microwave heating apparatuses disclosed herein may be useful for blow molding processes, such as for the formation of blown bottles, for example.

In other embodiments, microwave heating apparatuses disclosed herein may be useful in applications where the polymer being processed is not completely molten. For example, microwave heating apparatuses may be used to selectively heat a select portion of the polymer passing through the apparatus, thereby concentrating the heat energy to only that portion being further processed, such as by a forming, molding, or stamping process. This may enhance the structural integrity of the material handled during processing, may reduce cycle times, and may reduce the energy required for processing the material into the desired shape.

In other embodiments, microwave heating apparatuses disclosed herein may be useful in processing embossed sheets, including embossed sheet thermoforming. In conventional infrared thermoforming, heat input must pass through the surface of the sheet, and often reduces the retention of the embossing structure or surface details. In addition to the reduced heating cycles, as described above, microwave heating apparatuses may allow for increased retention of embossing structures during processing due to the reduced energy footprint imparted to the sheet.

In other embodiments, selective heating may allow the use of microwave sensitive layers of polymer interspersed with non-sensitive layers. Layered polymers may provide for: optimum temperature profiling; the use of pulsed microwave energy during polymer processing; the selective placement of the microwave emitters providing for heating of specific regions of a part; and other manifestations which may provide for preferential or selective heating by virtue of the microwave sensitivity of one or more thermoplastic parts or layers.

### EXAMPLES

### Example 1

A microwave heating apparatus, similar to that illustrated in FIG. 2, includes a GU 300 SMPS 3 kW microwave generator unit, by Industrial Microwave Systems, combined with a Philips 2722 IGS 2004 circulator rated at 2.425-2.475 Ghz. These components are operatively connected with a resonant chamber for the heating of a polymeric sheet. A transport system is also operatively coupled to the resonant cavity to transport the samples being heated from a sample magazine through the microwave applicator and to the thermoforming stage for processing. Tuning of the E-field within the resonant cavity is controlled via adjustment of the piston location using a Lenzo servomotor that by rotation moves the piston up or down.

A polypropylene sheet (homopolymer), 4 mm thick, and having 14 weight percent Zeolite A, is passed through and heated using the microwave heating apparatus at a power setting of 1200 Watts, and the temperature of the sheet exiting the resonant cavity is measured as a function of time. For comparative purposes, three runs are conducted with the microwave heating apparatus tuned using a stationary sample. Two runs are then conducted while controlling the position of the adjustable piston via a control system. One run is controlled for about 90 seconds, the other for 130 seconds

The processing of the moving samples with and without control results in drastic differences in sample temperature, as illustrated in FIG. 5. The runs with no tuning of the resonant cavity result in 30° C. variances in sample temperature, whereas control of the piston position to effect tuning of the resonant cavity results in a reasonably constant sample temperature, about a 5° C. deviation from set point. Additional improvements may be made to the tuning, such as by improved settings for the system gain for the proportional, integral, and/or derivative measurements of deviation from set point over time.

As illustrated by the above results, system drift and material geometry changes and compositional changes may make system control virtually impossible. By introducing a continuous tuning, combined with power control in some embodiments, based on thermal readings and electrical field probe(s), it may be possible to obtain a constant temperature distribution across the polymeric sheet being heated. This continuous fine tuning may be achieved by any means, such as the servomotor, or hydraulic or pneumatic piston displacement or a more sophisticated fluttering device that can react virtually instantaneous to the measured E-field.

The transport system itself should have a minimal effect on the dielectric conditions inside the cavity. The ideal transport system does not enter the cavity itself but moves the material inside the cavity though external means such as pushing or pulling the material. In the case that the size of parts are of similar dimensions as the cavity, it might be necessary to support the material as to not fall inside the cavity. This may be accomplished via a dielectric inert material which does not heat at the used microwaving conditions or by a supporting (side ways or gravitational support) system that is regularly fed through the cavity as to avoid heating of the transportation system itself, either through the microwaves or by conduction of the material to be heated material. If the transportation system passes through the cavity, the tuning should be such that it accommodates the changing of the e-field by the transportation system by tuning accordingly.

Embodiments disclosed herein may provide for rapid, volumetric heating of a thermoplastic material. Embodiments may also provide for selective heating of discrete parts of a thermoplastic structure, such as individual layers in a laminated or co-extruded multilayer structure, for example. With regard to polymer processing, this technology may offer many advantages for designers and processors, including selective, rapid heating; reduced heating/cooling cycle times (high speed); high energy efficiency and other environmental benefits such as reduced emissions (as it is a dry and fumeless process) and increased recycling potential (through enabling the more widespread use of self-reinforced single material components); preservation of properties in self-reinforced parts (reduces risk of reversion); increased productivity; improved part quality and strength; and minimization of thermal degradation due to reduced residence time in a thermal process, and therefore thermal stabilization additives can be reduced in polymer formulation.

Embodiments disclosed herein may provide a microwave heating unit providing uniform energy density and high field strength. The microwave heating apparatus may be capable of establishing very high electric fields to heat very weakly absorbing polymers rapidly and controllably through the application of microwave energy. Additionally, control systems may be used to maintain the E-field while processing a moving substrate, where the control system adapts the microwave heating apparatus to account for compositional, size, and other variances in the material being heated.

Advantageously, embodiments disclosed herein may provide reduced heating times, reducing overall fabrication cycle time and hence reduced piece part cost. Embodiments disclosed herein may also provide reduced cooling times as a result of the use of selective heating, introducing “heat sinks” within a material that is being processed. Additionally, volumetric heating eliminates the need for “surface” or “contact” heating and therefore eliminates the potentially deleterious effects of high polymer surface temperatures. Volumetric heating also eliminates the undesirable temperature gradient through the sheet thickness.

Embodiments disclosed herein may also advantageously provide improved productivity through reduced overall cycle times and reduced system energy requirements. Embodiments disclosed herein may also provide tailored thermal profiling providing optimum thermoforming conditions for all thermoplastic materials and, in particular, enabling the thermoforming of thick thermoplastic polyolefin sheet, which otherwise has an unacceptably narrow processing window.

While the invention has been described with respect to a limited number of embodiments, those skilled in the art, having benefit of this disclosure, will appreciate that other embodiments can be devised which do not depart from the scope of the invention as disclosed herein. In particular, embodiments of the present invention may also use a single emitter rather than multiple emitters. Accordingly, the scope of the invention should be limited only by the attached claims.

1. A method for processing a thermoplastic material, the method comprising:
passing a thermoplastic material through a microwave heating apparatus at a selected feed rate;
wherein the microwave heating apparatus comprises:
a microwave emitter for supplying microwave energy to a resonant cavity;
the resonant cavity comprising at least one inlet and at least one outlet, the inlets and outlets collectively forming a passageway for passing the thermoplastic material through the resonant cavity; and
a movable piston configured to adjust a length of the resonant cavity;
exposing the thermoplastic material to microwaves in the resonant cavity, wherein the exposing causes an increase in temperature of at least a portion of the thermoplastic material;
measuring an e-field generated by the microwave emitter; and
adjusting a position of the movable piston in response to the measured e-field; and, processing the thermoplastic material.

2. The method of claim 1, further comprising:
measuring a temperature of the thermoplastic material; and,
adjusting at least one of a position of the movable piston, a power input to the microwave generator, and a feed rate of the thermoplastic material in response to the measured temperature.

3. The method of claim 1, further comprising using a programmable logic controller to effect the adjusting in response to at least one of the measured e-field and the measured temperature.

4. (canceled)

5. The method of claim 1, wherein the movable piston further comprises a fluttering piston, the method further comprising fluttering the fluttering piston.

6. The method of claim 1, the microwave heating apparatus further comprising a variable power source operatively coupled to the microwave emitter, the method further comprising controlling a power input to the microwave emitter from the variable power source.

7. The method of claim 1, the microwave heating apparatus further comprising at least one additional tuning device comprising at least one of an iris plate, a phase shifter, an EH tuner, a twin stub tuner, a four stub tuner, and a movable piston to adjust a length of a resonant cavity, and the method further comprising tuning a frequency of the microwave energy using the at least one additional tuning device.

8. The method of claim 1, further comprising cooling the thermoplastic material.

9. The method of claim 1, wherein the selected feed rate is within the range from 1 to 75 mm/second.

10. The method of claim 1, wherein the processing comprises at least one of sheet extrusion, co-extrusion, foam extrusion, injection molding, foam molding, blow molding, injection stretch blow molding, and thermoforming.

11. The method of claim 1, further comprising adjusting a position of the thermoplastic material in the resonant cavity.

12. The method of claim 11, further comprising determining a position of a maxima in E-field within the resonant cavity.

13. The method of claim 1, further comprising adjusting a composition of the thermoplastic material in response to at least one of the measured e-field and the measured temperature.

14. An apparatus for heating a thermoplastic material, wherein the thermoplastic material comprises a microwave-sensitive polymeric region, the apparatus comprising:
a microwave emitter for supplying microwave energy to a resonant cavity;
the resonant cavity comprising at least one inlet and at least one outlet, the inlets and outlets collectively forming a passageway for passing the thermoplastic material through the resonant cavity;
a movable piston configured to adjust a length of the resonant cavity;
an e-field sensor for measuring an e-field generated by the microwave emitter; and
a control system for adjusting a position of the movable piston based on data received from the e-field sensor.

15. The apparatus of claim 14, wherein the movable piston comprises a fluttering piston.

16. (canceled)

17. The apparatus of claim 16, wherein the control system is a closed loop control system configured to provide real time tuning of a resonant frequency of each cavity to a frequency of the microwave energy generated while heating the thermoplastic material.

18. The apparatus of claim 14, further comprising a variable power source operatively coupled to the at least one microwave emitter.

19. The apparatus of claim 18, wherein the control system is configured to adjust a power input to the microwave emitter.

20. The apparatus of claim 14, wherein the microwave emitter comprises a microwave generator selected from the group consisting of a magnetron, a klystron, a gyrotron, a traveling wave tube, a microwave launcher, or combinations thereof.

21. The apparatus of claim 14, further comprising at least one additional tuning device selected from the group consisting of an iris plate, an EH tuner, and a four stub tuner.

22. The apparatus of claim 14, further comprising at least one of an e-field probe, an infra-red pyrometer, a thermal imaging device, and a phase shifter.

23. (canceled)
